(19) United States
(12) Patent Application Publication
(10) Pub. No.: US 2024/0181605 A1
(43) Pub. Date: Jun. 6, 2024

(54) CABLE TIE PLIER

(71) Applicants: Zhuji ITOP Hardware Tools Co., Ltd., Zhuji (CN); ZHEJIANG IWISS ELECTRIC CO., LTD., Leqing (CN)

(72) Inventors: Xiaoming DENG, Zhuji (CN); Yuejuan SHEN, Zhuji (CN)

(73) Assignees: Zhuji ITOP Hardware Tools Co., Ltd., Zhuji (CN); ZHEJIANG IWISS ELECTRIC CO., LTD., Leqing (CN)

(21) Appl. No.: 18/527,533

(22) Filed: Dec. 4, 2023

(30) Foreign Application Priority Data
Dec. 5, 2022 (CN) 202223301993.5
Nov. 7, 2023 (CN) 202323003057.0

(51) Int. Cl. B25B 7/22; B25B 7/14; B65B 13/02; B65B 13/18

(52) U.S. Cl. CPC B25B 7/22; B25B 7/14; B65B 13/027; B65B 13/185

(57) ABSTRACT

A tie plier is provided, which includes a head, a locking assembly, a first and second handle. The first handle is connected to an end of the head, the locking assembly is movably connected to the head, a ratchet assembly is provided on the second handle and is connected with the locking assembly, a reset tension spring is connected between the second handle and the head, a jaw is provided on the head and is arranged close to the locking assembly, and a cutting assembly is provided at a side of the jaw. The tie plier can be operated by one hand to tighten the tie. Moreover, the tightening mechanism is compact and simplified in structure, and a holding angle between the first and second handle can be adjusted, thus a one-handed operation can be carried out more conveniently, and tie tightening operations in various special occasions can be made.

### CROSS REFERENCE TO THE RELATED APPLICATIONS

This Non-provisional application claims priority under 35 U.S.C. § 119(a) on Chinese Patent Application No(s). CN2202223301993.5 filed on Dec. 5, 2022, and CN 202323003057.0 filed on Nov. 7, 2023, the entire contents of which are hereby incorporated by reference.

### TECHNICAL FIELD

The disclosure relates to the technical field of tie tools, in particular to a tie plier.

### BACKGROUND ART

Ties are widely used to bind and fix wires, devices and other articles. A traditional tie includes a head and a tie body. The tie body is wound around a bound article by encircling the article once, so that a tail of the tie body passes through the head of the tie, and the tie body is locked in the head of the tie through a clamping groove provided on the tie body and a clamping part provided on the head, so as to bind and fix the article.

During operations of an existing tie plier, one of its handles keeps motionless, and the other of the handles is manually controlled to reciprocate so as to realize rotation of a tightening part on the tie plier, and thus the tie is tightened. With this structure, an operator needs to operate with both hands, that is, with one hand holding down the one of the handles and the other of the hands causing the other of the handles to reciprocate, which is very inconvenient to tighten the tie in some special occasions. Moreover, the tightening part on the tie plier is complicated in structure, which results in complicated assembly and a bulky product as a whole of the tie plier.

### SUMMARY

To solve the above problems, the technical scheme provided in the disclosure is as follows.

A tie plier includes a head, a locking assembly, a first handle and a second handle. The first handle is connected to an end of the head, the locking assembly is movably connected to the head, a ratchet assembly is provided on the second handle and is connected with the locking assembly, a reset tension spring is connected between the second handle and the head, and a jaw is provided on the head and is arranged close to the locking assembly, and a cutting assembly is provided at a side of the jaw.

In the disclosure, it is further provided that the locking assembly includes a tightening part, a transmission part, a rotating shaft part and a positioning part. The tightening part is provided with a tightening groove, the tightening part is arranged close to the jaw, the ratchet assembly is connected to the transmission part, a one-way bearing is provided on the head, the one-way bearing is connected to the rotating shaft part, the positioning part is connected with a positioning piece, and the positioning piece is arranged at a side of the head.

In the disclosure, it is further provided that the second handle is defined with a rotating hole, a side wall of the rotating hole is provided with an inner groove, and the ratchet assembly includes a gear ring, a pawl and a pawl resetting member. Both the pawl and the pawl resetting member are arranged in the inner groove, one end of the pawl resetting member abuts against the inner groove, and the other end of the pawl resetting member is connected with the pawl; an outer periphery of the gear ring is provided with external teeth, and the gear ring is arranged in the rotating hole, the pawl is connected with the external teeth of the gear ring; and the transmission part is connected with the gear ring.

In the disclosure, it is further provided that the head is defined with a transmission cavity, the locking assembly penetrates through the transmission cavity, the ratchet assembly is arranged in the transmission cavity, the one-way bearing is connected to a side wall of the transmission cavity, and a limiting shaft is provided in the transmission cavity, and the limiting shaft is arranged proximate to the reset tension spring and is located on a path of rotation of the second handle around the locking assembly.

In the disclosure, it is further provided that a first tension spring hole is provided at a position on the transmission cavity away from the first handle, and a second tension spring hole is provided on a side of the second handle proximate to the first tension spring hole, one end of the reset tension spring is connected in the first tension spring hole, and the other end of the reset tension spring is connected in the second tension spring hole.

In the disclosure, it is further provided that the tightening groove on the tightening part is provided at a four-part position, a six-part position, an eight-part position or a ten-part position.

In the disclosure, it is further provided that the head is provided with an adjusting part, the adjusting part is provided with a rotating shaft, an end of the first handle is connected to the rotating shaft, the adjusting part is provided with at least two adjusting grooves, the first handle is defined with a waist-shaped hole, an adjusting pin is movably connected in the waist-shaped hole; an adjusting torsion spring is provided on the first handle, one end of the adjusting torsion spring abuts against the first handle, and the other end of the adjusting torsion spring abuts against the adjusting pin, and the adjusting pin is arranged in different adjusting grooves to change a connection position and an operation angle of the first handle on the head.

In the disclosure, it is further provided that the cutting assembly includes a rotary cutter, a reset torsion spring and a handle. The head is provided with a rotary cutter hole in which the rotary cutter is connected, the handle is movably inserted at one end of the rotary cutter, the reset torsion spring is sleeved on the rotary cutter, one end of the reset torsion spring is connected to the head, the other end of the reset torsion spring is connected to the handle, and the other end of the rotary cutter is provided with a cutter head which is located in the jaw.

In the disclosure, it is further provided that a limiting part is provided at a side of the head proximate to the handle, and the limiting part is respectively located at a front end and a back end of the handle rotating around the rotary cutter, and two ends of the handle are provided with an anti-off part.

In the disclosure, it is further provided that a positioning groove is provided at a middle part of the rotary cutter, the head is provided with a positioning pin, and the positioning pin is connected in the positioning groove.

Alternatively, the jaw is not completely arranged through the head, for example, one end of the jaw is closed and sealed.

Compared with related art, the technical schemes provided in the disclosure have the following beneficial effects:

Specific use principle of the tie plier in technical schemes in the disclosure is that the tie is clamped into the jaw and the locking assembly in turn, and the first handle and the second handle are held for continuous pressing; with the ratchet assembly and the reset tension spring provided, when the second handle rotates close to the first handle, the second handle drives the locking assembly to rotate to tighten the tie, and when the second handle rotates in a resetting way away from the first handle, the locking assembly may not rotate with the second handle, thus realizing continuous tightening actions of the tie. In the disclosure, the tie plier can be operated by one hand or two hands by changing an angle between the handles to tighten the tie, which is very convenient to use, and the tightening mechanism is compact and simplified in structure, making the tie plier more compact and light.

According to the technical schemes, the locking assembly is provided with a plurality of tightening grooves, so that there is always a tightening groove corresponding to the jaw regardless of an angle of the locking assembly, which facilitates placing of the tie into the locking assembly and is very convenient to operate.

According to the technical schemes, a connection position of the first handle on the head can also be adjusted, so that a holding angle between the first handle and the second handle can be adjusted, and thus a one-handed operation can be carried out more conveniently, and tie tightening operations in various special occasions can be made.

Accord to the technical schemes, the cutting assembly is used for cutting the tie after the tie is tightened, and because the handle is movable on the rotary cutter, the operator can use different operating parts of the handle to cut the tie at a side of the first handle or at a side of the second handle, which can be used more flexibly.

### BRIEF DESCRIPTION OF THE DRAWINGS

FIG. 1 is a perspective view of an embodiment of the present disclosure in a first use state;

FIG. 2 is a perspective view of an embodiment of the present disclosure in a second use state;

FIG. 3 is a cross-sectional view of FIG. 1;

FIG. 4 is an exploded view of FIG. 1;

FIG. 5 is an exploded view of a second handle, a locking assembly and a ratchet assembly according to an embodiment of the present disclosure;

FIG. 6 is an exploded view of a head and a cutting assembly according to an embodiment of the present disclosure;

FIG. 7 is a schematic structural view of a tie plier according to another embodiment of the present disclosure;

FIG. 8 is a schematic view of a shift lever of a tie plier according to another embodiment of the present disclosure;

FIG. 9 is a cross-sectional view of a tie plier according to another embodiment of the present disclosure;

FIG. 10 is a schematic diagram of another handle structure according to an embodiment of the present disclosure;

FIG. 11 is a schematic view of a sleeve in FIG. 10; and

FIG. 12 is a schematic diagram of another limiting boss in an embodiment of the present disclosure.

### DETAILED DESCRIPTION

In order to further understand contents of the present disclosure, the present disclosure will be described in detail with reference to drawings and examples.

It should be noted that the embodiments in the present disclosure and the characteristics in the embodiments can be combined mutually in the case of no conflict.

In description of this disclosure, it should be noted that unless otherwise specified and limited, terms “installing”, “coupling” and “connecting” should be understood broadly, for example, it can be “fixedly connecting”, “integrally connecting”, or “detachably connecting”; or it can be “mechanically connecting” or “electrically connecting”, or it can be “communicating within two elements”; or it can be “directly connecting” or “indirectly connecting through an intermediate medium”, and specific meanings of the above terms can be understood according to specific situations for ordinary shilled in the art.

### Embodiment 1

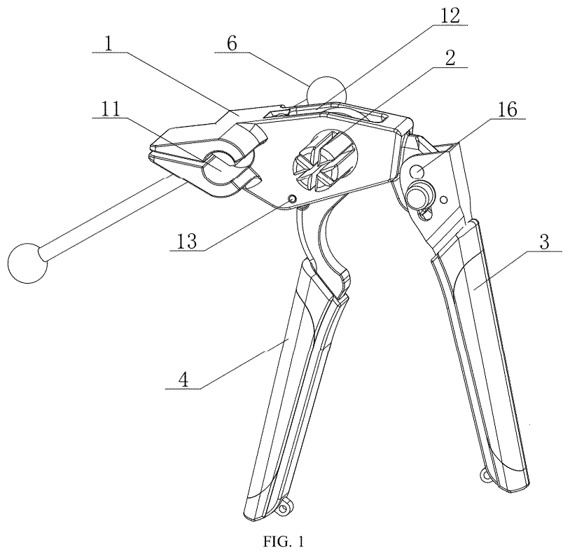

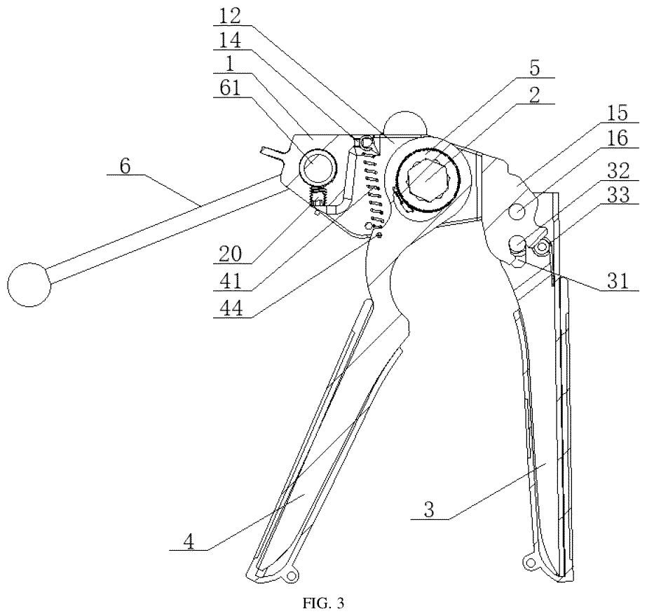

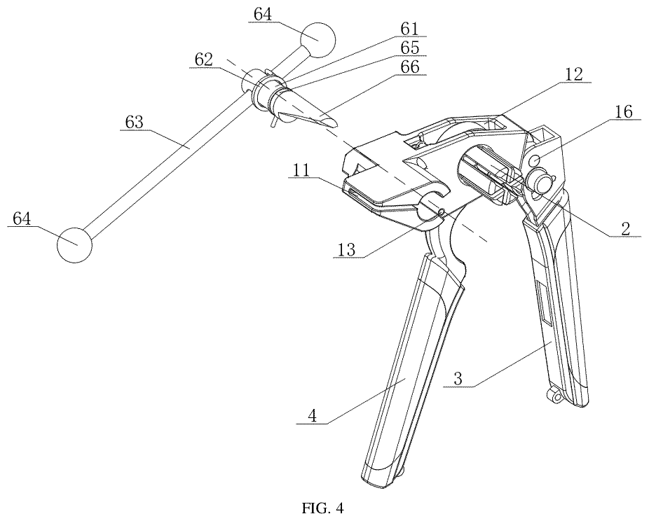

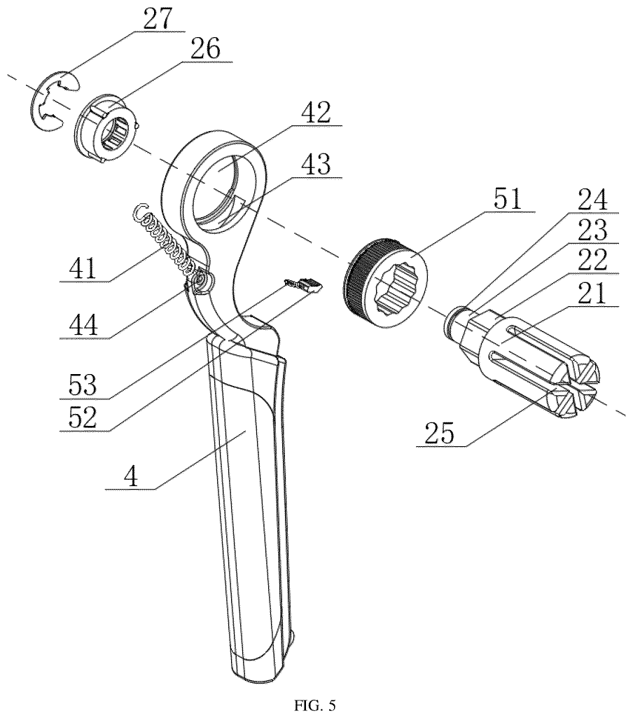

With reference to FIG. 1 to FIG. 6, the technical scheme of the disclosure lies in a tie plier, which includes a head 1, a locking assembly 2, a first handle 3 and a second handle 4. The first handle 3 is connected to an end of the head 1, the locking assembly 2 is movably connected to the head 1, a ratchet assembly 5 is provided in on the second handle 4 and is connected with the locking assembly 2, a reset tension spring 41 is connected between the second handle 4 and the head 1, and a jaw 11 is provided on the head 1 and is arranged close to the locking assembly 2, and a cutting assembly 6 is provided at a side of the jaw 11.

In the above embodiment, the jaw 11 is configured for guiding insertion and tightening of the tie, and the jaw 11 and the cutting assembly cooperate to cut the tie. The ratchet assembly 5 is configured for unidirectional transmission of the locking assembly 2 driven by the second handle 4. The locking assembly 2 is configured for pulling the tie to be tightened. The reset tension spring 41 is configured for resetting the second handle 4; the cutting assembly 6 is configured to cut the tie after tightening.

In this embodiment, the locking assembly 2 includes a tightening part 21, a transmission part 22, a rotating shaft part 23 and a positioning part 24. The tightening part 21 is provided with a tightening groove 25, the tightening part 25 is arranged close to the jaw 11, the ratchet assembly 5 is connected to the transmission part 22, a one-way bearing 26 is provided on the head 1, the one-way bearing 26 is connected to the rotating shaft part 23, the positioning part 24 is connected with a positioning piece 27, and the positioning piece 27 is arranged at a side of the head 1.

In this embodiment, the second handle 4 is defined with a rotating hole 42, a side wall of the rotating hole 42 is provided with an inner groove 43, and the ratchet assembly 5 includes a gear ring 51, a pawl 52 and a pawl resetting member 53. Both the pawl 52 and the pawl resetting member 53 are arranged in the inner groove 43, one end of the pawl resetting member 53 abuts against the inner groove 43, and the other end of the pawl resetting member 53 is connected with the pawl 52; an outer periphery of the gear ring 51 is provided with external teeth, and the gear ring 51 is arranged in the rotating hole 42, the pawl 52 is connected with the external teeth of the gear ring 51; and the transmission part 22 is connected with the gear ring 51.

In the embodiment described above, the transmission part 22 is a polygonal rotating shaft instead of a circular shaft, so that the ratchet assembly 5 can drive the locking assembly 2 to rotate when it rotates. Similarly, an inner hole of the gear ring 51 is a polygonal hole and is adapted to the transmission part 22.

In this embodiment, the head 1 is defined with a transmission cavity 12, the locking assembly 21 penetrates through the transmission cavity 12, the ratchet assembly 5 is arranged in the transmission cavity 12, the one-way bearing 26 is connected to a side wall of the transmission cavity 12, and a limiting shaft 13 is provided in the transmission cavity 12, and the limiting shaft 13 is arranged close to the reset tension spring 41 and is located on a path of rotation of the second handle 4 around the locking assembly 2.

In the above embodiment, the limiting shaft 13 is configured to limit a movable stroke of the second handle 4. The one-way bearing 26 further ensures that the locking assembly 2 does not rotate back, and the one-way bearing 26 and the head 1 remain relatively fixed.

In this embodiment, a first tension spring hole 14 is provided at a position on the transmission cavity 12 away from the first handle 3, and a second tension spring hole 44 is provided on a side of the second handle 4 proximate to the first tension spring hole 14, one end of the reset tension spring 41 is connected in the first tension spring hole 14, and the other end of the reset tension spring 41 is connected in the second tension spring hole 44.

In this embodiment, the tightening groove 25 on the tightening part 21 is provided at a four-part position, a six-part position, an eight-part position or a ten-part position; and the more the tightening grooves 25, the more easily the tie can be clamped on the tightening part 21, so that there is always a tightening groove 25 corresponding to the jaw 11 regardless of an angle of the locking assembly 2, which facilitates placing of the tie into the locking assembly 2 and is very convenient to operate.

In this embodiment, the head 1 is provided with an adjusting part 15, the adjusting part 15 is provided with a rotating shaft 16, an end of the first handle 3 is connected to the rotating shaft 16, the adjusting part 15 is provided with at least two adjusting grooves 17, the first handle 3 is defined with a waist-shaped hole 31, an adjusting pin 32 is movably connected in the waist-shaped hole 31; an adjusting torsion spring 33 is provided on the first handle 3, one end of the adjusting torsion spring 33 abuts against the first handle 3, and the other end of the adjusting torsion spring 33 abuts against the adjusting pin 32, and the adjusting pin 32 is arranged in different adjusting grooves 17 to change a connection position and an operation angle of the first handle 3 on the head 1. In other embodiments, an angle between the first handle and the head is not adjustable, that is, they are relatively fixed.

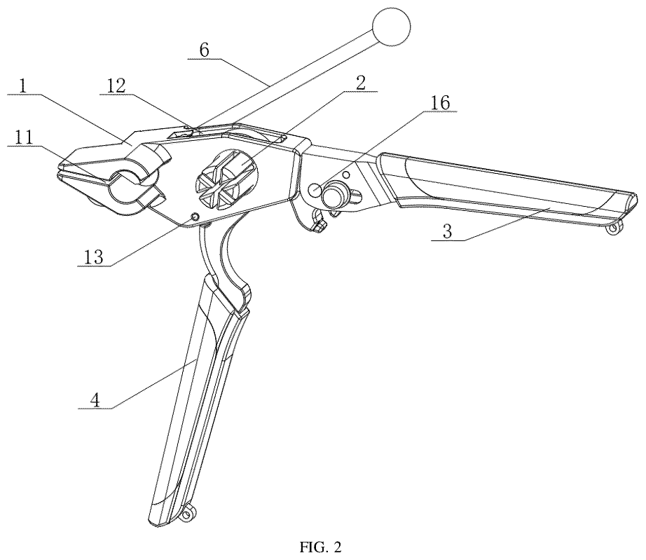

In the above embodiment, as shown in FIG. 6, there are two adjusting grooves 17. By adjusting the adjusting pin 32, the first handle 3 can be clamped into an upper adjusting groove and a lower adjusting groove, thus changing the connection position and operation angle of the first handle 3 on the head 1. As shown in FIGS. 1 and 2, the tie plier can be pressed for tightening operations by two hands or one hand in a first use state of FIG. 1 or a second use state of FIG. 2.

In this embodiment, the cutting assembly 6 includes a rotary cutter 61, a reset torsion spring 62 and a handle 63. The head 1 is provided with a rotary cutter hole 18 in which the rotary cutter 61 is connected, the handle 63 is movably inserted at one end of the rotary cutter 61, the reset torsion spring 62 is sleeved on the rotary cutter 61, one end of the reset torsion spring 62 is connected to the head 1, the other end of the reset torsion spring 62 is connected to the handle 63, and the other end of the rotary cutter 61 is provided with a cutter head 66 which is located in the jaw 11. The jaw 11 and the cutter head 66 cooperate to cut the tie.

In the embodiment described above, the handle 63 can move back and forth, which is suitable for different cutting angles, so that the operator can use different operating parts of the handle 63 to cut the tie at a side of the first handle or at a side of the second handle, such as at positions of the handle 63 as shown in FIG. 1 and FIG. 2.

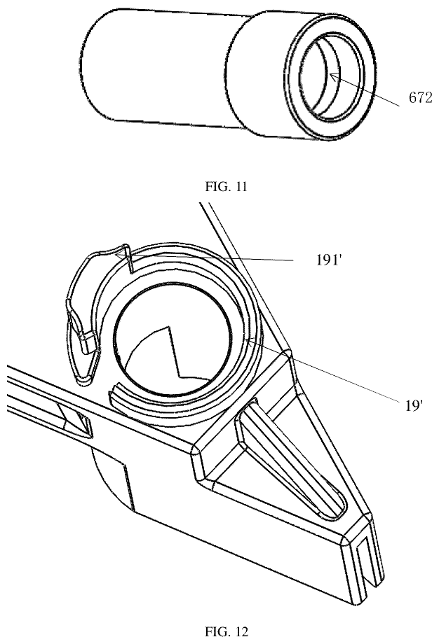

In this embodiment, a limiting part 19 is provided at a side of the head 1 proximate to the handle 63, and the limiting part 19 is respectively located at a front end and a back end of the handle 63 rotating around the rotary cutter 61, and the limiting part 19 is configured for limiting a round trip of the handle in operations. In other embodiments, as shown in FIG. 12, the limiting part 19 is a limiting boss 19′ with a notched annular structure, and a protrusion 191′ is formed upward on an upper side of the limiting boss 19′ to limit the handle. Two ends of the handle 63 are provided with an anti-off part 64. The anti-off part is of a spherical or quasi-spherical structure. In other embodiments, an anti-off part 64′ can be a bar nut, as shown in FIG. 10, and the anti-off part 64′ can be screwed with the two ends of the handle. Furthermore, as an alternative, in order to make the handle move more smoothly, a sleeve 67 is arranged outside the handle, one end of the reset torsion spring 62 is wound around an outer periphery of the sleeve, and a limiting step 671 is provided on the outer periphery of the sleeve to cooperate with the cutting assembly 6, and the handle can be moved in the sleeve. As shown in FIG. 11, an inner wall of the sleeve is further provided with a groove 672 for accommodating a rubber ring so as to form damping sliding connection with the handle.

In the embodiment described above, the limiting part 19 prevents the handle 63 from exceeding its stroke and damaging the reset torsion spring when cutting the tie.

In this embodiment, a positioning groove 65 is provided at a middle of the rotary cutter 61, and the head 1 is provided with a positioning pin or a positioning screw 20, the positioning pin or the positioning screw 20 is connected in the positioning groove 65. The positioning pin 20 or the positioning screw serves to prevent the rotary cutter 61 from deviating relative to the head 1.

Specific use principle of the tie plier according to the disclosure is that the tie is clamped into the jaw and the locking assembly in turn, and the first handle and the second handle are held for continuous pressing; with the ratchet assembly and the reset tension spring provided, when the second handle rotates close to the first handle, the second handle drives the locking assembly to rotate to tighten the tie, and when the second handle rotates in a resetting way away from the first handle and with action of the one-way bearing, the locking assembly may not rotate with the second handle, thus realizing continuous tightening actions of the tie.

### Embodiment 2

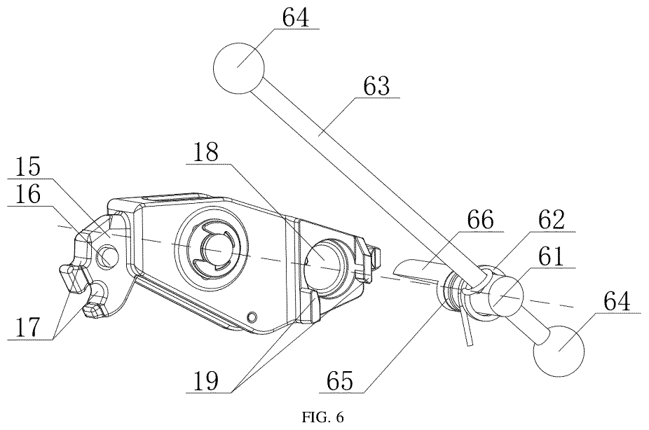

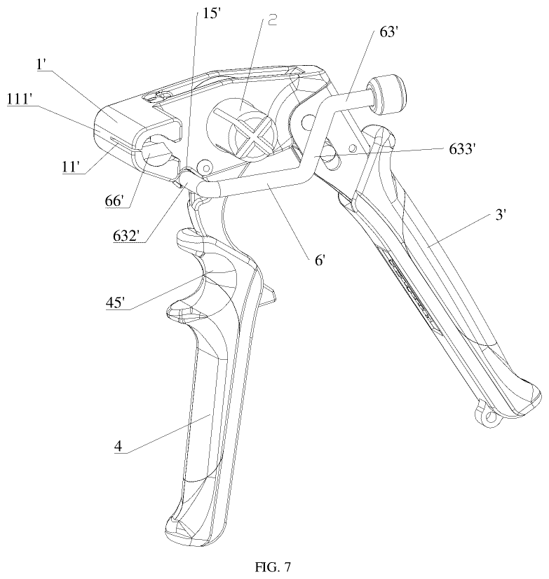

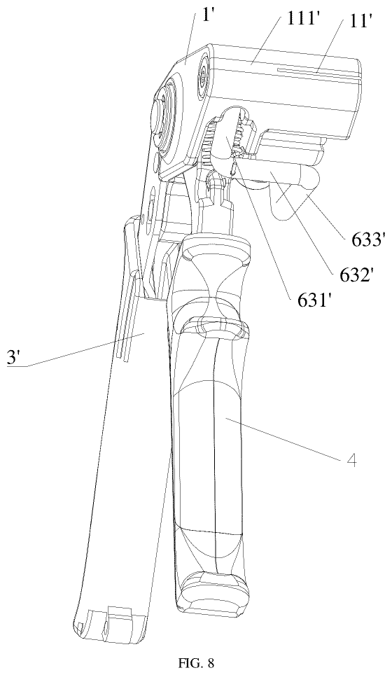

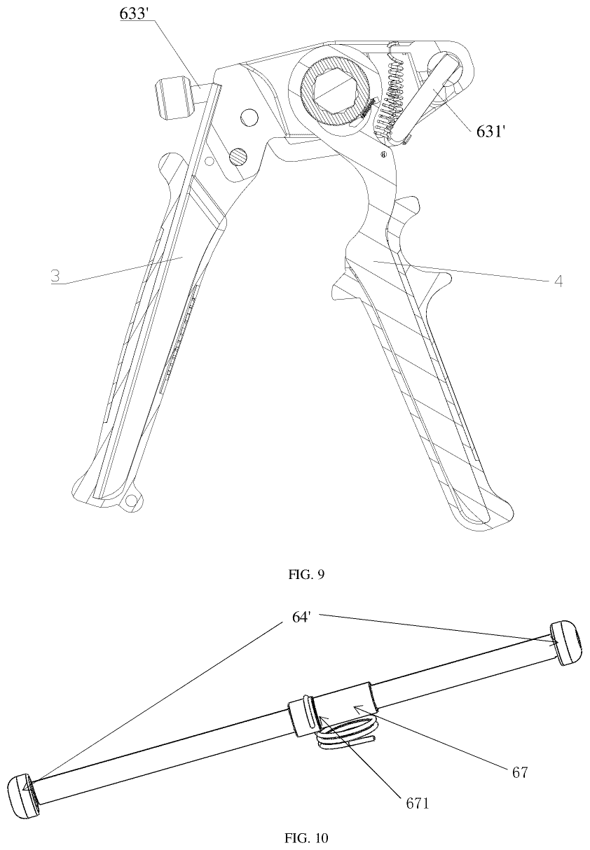

Referring to FIG. 7 to FIG. 9, another tie plier is provided in Embodiment 2. The second handle and the locking assembly are exactly the same as those in Embodiment 1, which thus will not be repeatedly described here, and only differences therebetween will be described below.

Another head 1′ is provided in Embodiment 2. In order to adapt to different types of ties, the head in this embodiment is shorter than that in Embodiment 1, that is, a length of the jaw 11′ is shorter than that in Embodiment 1. In contrast, the head in Embodiment 1 is pointed, and the head of this embodiment is a blunt or round head.

Another cutting assembly 6′ is provided in Embodiment 2. The cutting assembly 6′ includes a cutter head 66′ and a shift lever 63′. The cutter head rotates in the jaw, one end of the shift lever is connected with the cutter head, and the other end of the shift lever is proximate to the first handle. Different from the handle 63 in Embodiment 1, the shift lever in this embodiment is provided so as not to move back and forth, and the lever 63′ and the locking assembly in this embodiment are arranged on a same side of the plier, both on a side of the jaw opposite to a sealed end. In Embodiment 1, the shift lever 63′ and the locking assembly are respectively arranged on opposite sides of the plier.

Alternatively, the shift lever 63′ includes a first linkage 631′, a second linkage 632′ and a third linkage 633′ which are sequentially connected. The first linkage 631′ is connected with the cutter head 66′, and the third linkage 633′ is proximate to an end of the first handle 3′ connected with the head. The first linkage 631′, the second linkage 632′ and the third linkage 633′ can be integrally designed, and the third linkage 633′ can be bent for many times to avoid the locking assembly to be proximate to the first handle 3′.

Alternatively, a groove 15′ is provided at a bottom of the head, and the second linkage 632′ movably abuts against the groove 15′. The groove 15′ is movably abutted against the second linkage 632′ to limit a stroke of the shift lever 63′.

Alternatively, a plane where the third linkage 633′ is located does not overlap with plane where the head, the second handle 4′ and the first handle 3′ are located. It is ensured that the third linkage 633′ does not interfere with the head, the second handle 4′ and the first handle 3′ during movement.

Alternatively, the cutter head 66′ includes a rotating part and a blade connected with the rotating part, the first linkage is connected with the rotating part, and the blade is rotatably located in the jaw.

Because an end of the shift lever 63′ away from the cutter head 66′ is proximate to the first handle 3′, it is convenient for the user to shift the shift lever 63′ with a thumb while holding the first handle 3′, so that the shift lever 63′ drives the cutter head 66′ to rotate in the jaw 11′, and thus redundant ties are cut off. In this way, fixing and cutting of the ties can be completed with one hand, which is more convenient to use.

Alternatively, the second handle 4′ is provided with a grip part 45′ for a user to hold.

As an alternative, the cutter head in this embodiment is located at a lower part of the jaw, that is, a cutting edge is located in a direction away from a plier handle, and the cutter head in Embodiment 1 is located at a upper part of the jaw, that is, the cutting edge is located in a direction toward the plier handle. In other embodiments, the cutter head in the Embodiment 1 can also be arranged at the lower part of the jaw, and the cutter head in this embodiment can also be arranged at the upper part of the jaw.

As an alternative embodiment, another first handle 3′ is provided in this embodiment, which is different from Embodiment 1 in that an angle between the first handle 3′ and the head in this embodiment are not adjustable, and the head is also adjusted accordingly, for example, the adjusting part 15 in Embodiment 1 may not be provided, and of course, a same first handle with an adjustable angle as in the first embodiment can also be adopted in this embodiment.

The present disclosure and embodiments thereof are described above in an illustrative manner, which is not restrictive; and what is shown in the drawings is only one of the embodiments of the present disclosure, and its actual structure is not limited thereto. Therefore, structures and embodiments similar to the technical scheme designed by those of ordinary skilled in the art inspired by this disclosure without creativity, without departing from the creative purpose of the present disclosure, are all within a protection scope of the present disclosure.

What is claimed is:

1. A tie plier, comprising:
a head,
a locking assembly,
a first handle. and
a second handle,
wherein the first handle is connected to an end of the head, the locking assembly is movably connected to the head, a ratchet assembly is provided on the second handle and is connected with the locking assembly, a reset tension spring is connected between the second handle and the head, a jaw is provided on the head and is arranged close to the locking assembly, and a cutting assembly is provided at a side of the jaw.

2. The tie plier according to claim 1, wherein the locking assembly comprises a tightening part, a transmission part, a rotating shaft part and a positioning part, wherein the tightening part is provided with a tightening groove, the tightening part is arranged close to the jaw, the ratchet assembly is connected to the transmission part, a one-way bearing is provided on the head, the one-way bearing is connected to the rotating shaft part, the positioning part is connected with a positioning piece, and the positioning piece is arranged at a side of the head.

3. The tie plier according to claim 2, wherein the second handle is defined with a rotating hole, a side wall of the rotating hole is provided with an inner groove; and the ratchet assembly comprises a gear ring, a pawl and a pawl resetting member, both the pawl and the pawl resetting member are arranged in the inner groove, one end of the pawl resetting member abuts against the inner groove, and the other end of the pawl resetting member is connected with the pawl; an outer periphery of the gear ring is provided with external teeth, and the gear ring is arranged in the rotating hole, the pawl is connected with the external teeth of the gear ring; and the transmission part is connected with the gear ring.

4. The tie plier according to claim 3, wherein the head is defined with a transmission cavity, the locking assembly penetrates through the transmission cavity, the ratchet assembly is arranged in the transmission cavity, the one-way bearing is connected to a side wall of the transmission cavity, and a limiting shaft is provided in the transmission cavity, and the limiting shaft is arranged proximate to the reset tension spring and is located on a path of rotation of the second handle around the locking assembly.

5. The tie plier according to claim 4, wherein a first tension spring hole is provided at a position on the transmission cavity away from the first handle, and a second tension spring hole is provided on a side of the second handle proximate to the first tension spring hole, one end of the reset tension spring is connected in the first tension spring hole, and the other end of the reset tension spring is connected in the second tension spring hole.

6. The tie plier according to claim 2, wherein the tightening groove on the tightening part is provided at a four-part position, a six-part position, an eight-part position or a ten-part position.

7. The tie plier according to claim 1, wherein the head is provided with an adjusting part, the adjusting part is provided with a rotating shaft, an end of the first handle is connected to the rotating shaft, the adjusting part is provided with at least two adjusting grooves, the first handle is defined with a waist-shaped hole, an adjusting pin is movably connected in the waist-shaped hole; an adjusting torsion spring is provided on the first handle, one end of the adjusting torsion spring abuts against the first handle, and the other end of the adjusting torsion spring abuts against the adjusting pin, and the adjusting pin is arranged in different adjusting grooves to change a connection position and an operation angle of the first handle on the head.

8. The tie plier according to claim 1, wherein the cutting assembly comprises a rotary cutter, a reset torsion spring and a handle, wherein the head is provided with a rotary cutter hole in which the rotary cutter is connected, the handle is movably inserted at one end of the rotary cutter, the reset torsion spring is sleeved on the rotary cutter, one end of the reset torsion spring is connected to the head, the other end of the reset torsion spring is connected to the handle, and the other end of the rotary cutter is provided with a cutter head which is located in the jaw.

9. The tie plier according to claim 8, wherein a limiting part is provided at a side of the head proximate to the handle, and the limiting part is respectively located at a front end and a back end of the handle rotating around the rotary cutter, and two ends of the handle are provided with an anti-off part.

10. The tie plier according to claim 8, wherein a positioning groove is provided at a middle part of the rotary cutter, the head is provided with a positioning pin or positioning screw, and the positioning pin or positioning screw is connected in the positioning groove.

11. The tie plier according to claim 1, wherein the cutting assembly comprises a cutter head and a shift lever, wherein the cutter head is rotatably located in the jaw, one end of the shift lever is connected with the cutter head, the other end of the shift lever is proximate to the first handle, and the shift lever and the locking assembly are arranged on a same side of the plier.

12. The tie plier according to claim 11, wherein the shift lever comprises a first linkage, a second linkage and a third linkage which are sequentially connected, wherein the first linkage is connected with the cutter head, and the third linkage is proximate to an end of the first handle connected with the head.

13. The tie plier according to claim 11, wherein a groove is provided at a bottom of the head, and the second linkage movably abuts against the groove.
